(19) United States
(12) Patent Application Publication
(10) Pub. No.: US 2002/0088297 A1
(43) Pub. Date: Jul. 11, 2002

(54) Rear brake cable mechanism for bicycle

(76) Inventor: Tsai-Er Lin, Chang-Hua City (TW)

Correspondence Address: TSAI-ER LIN, P.O. BOX 487, Chang-Hua City, 500, TW

(21) Appl. No.: 09/911,416

(22) Filed: Jul. 25, 2001

(30) Foreign Application Priority Data
Jan. 11, 2001 (TW) 090200505

(51) Int. Cl. F16C 1/10

(52) U.S. Cl. 74/500.5; 74/502.4

(57) ABSTRACT

A bicycle rear brake cable mechanism comprises a first cable secured to a brake lever, a second cable secured to a swivel, a third cable secured to swivel, and a fourth cable; an upper brake on the joint of first and second cables and comprising a first fastener secured to first cable, and a first engagement member secured to first fastener and having a fork section clung to second cable; and a lower brake comprising a first section on rear brake, first section including a second fastener with fourth cable passed through, and a second engagement member secured to second fastener and having a fork section secured to one end of fourth cable; and a second section including a third fastener secured to the other end of fourth cable, and a third engagement member including an aperture with third fastener passed through and a fork section clung to third cable.

### FIELD OF THE INVENTION

The present invention relates to bicycle brake and more particularly to a rear brake cable mechanism for bicycle with improved characteristics.

### BACKGROUND OF THE INVENTION

A conventional bicycle brake is shown in FIG. 1 to 3. In FIG. 1, the rear brake cable mechanism comprises a brake lever A3 secured to handlebar, an upper brake assembly A5 on the brake cable which is extended down from brake lever A3 through a swivel A4 coupled between handlebar and front tube A11 (also coupled to front fork A2) to a rear brake A7, and a lower brake assembly A6 on the brake cable adjacent a down tube A1. Only upper brake assembly A5 will be described in detail below since lower brake assembly A6 is a mirror image of upper brake assembly A5. As shown in FIGS. 2 and 3, upper brake assembly A5 comprises a single thread cable A51 having one end coupled to brake lever, an enlargement A52 having one side fixed to the other end of single thread cable A51, a double thread cable A53 having one end fixed to the other side of enlargement A52 and the other end coupled to lower brake assembly A6, a cylindrical member A54 having two rear holes with double thread cable A53 passed through and a front hole, and a coupling member A55 having a rear hollow cylindrical member in conjunction with the front hole of cylindrical member A54 for slidably receiving the enlargement A52 and a front hollow cylindrical member with single thread cable A51 received therein wherein the rear and front hollow cylindrical members of the coupling member A55 are threadedly secured together. The operation is very simple. In brief, press the fork portion of brake lever A3 toward each other to tauten the single thread cable A51. Thus enlargement A52 slightly slides to cause double thread cable A53 to move, resulting in an activation of the rear brake A7.

However, the previous design suffered from several disadvantages. For example, enlargement A52 tends to break when the brake force is large. Further, manufacturing of enlargement A52 and the coupled brake cable A51 and A53 is complex and the tolerance thereof is low. Furthermore, assembly of the rear brake cable mechanism is tedious. Thus improvement exists.

### SUMMARY OF THE INVENTION

It is an object of the present invention to provide a rear brake cable mechanism mounted on a bicycle comprising a brake cable assembly comprising a first cable having a stop in one end secured to the brake lever, a second cable having a stop at either end secured to a swivel at the joint of the front tube and the front fork, a third cable having a stop at either end secured to the swivel, and a fourth cable; an upper brake assembly on the joint of the first and the second cables, the upper brake assembly comprising a first fastener having a through hole with the first cable secured thereto, and a first engagement member secured to the first fastener, the first engagement member having a bent fork section with the second cable clung therein; and a lower brake assembly comprising a first section on the rear brake, the first section including a second fastener having a through hole with the fourth cable passed through, and a second engagement member secured to the second fastener, the second engagement member having a bent fork section secured to one end of the fourth cable; and a second section including a third fastener having a through hole with the other end of the fourth cable secured thereto, and a third engagement member including an aperture with the third fastener passed through, the third engagement member having a bent fork section with the third cable clung therein.

The above and other objects, features and advantages of the present invention will become apparent from the following detailed description taken with the accompanying drawings.

### BRIEF DESCRIPTION OF THE DRAWINGS

FIG. 1 is a perspective view of a conventional rear brake cable mechanism mounted on a bicycle;

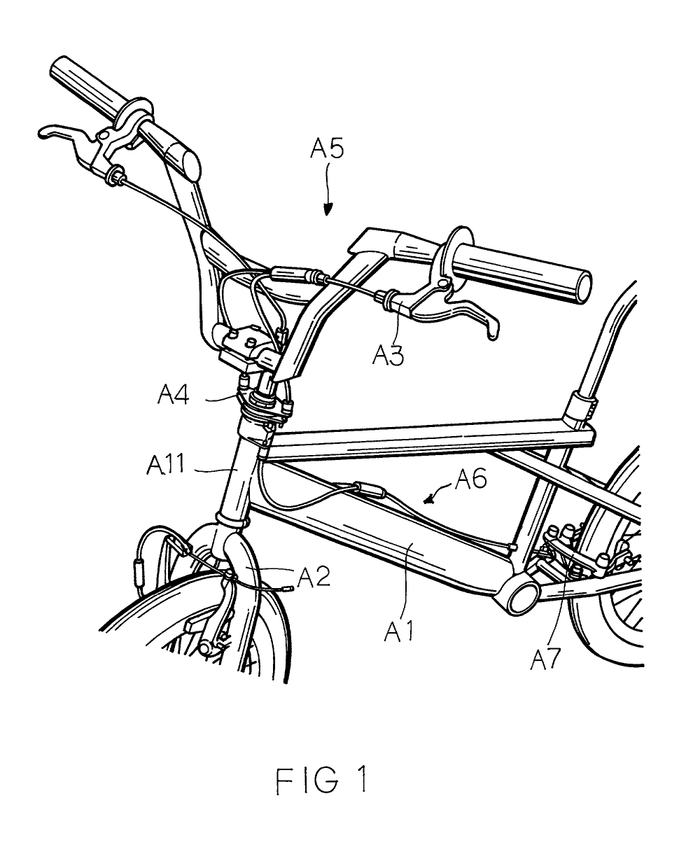

FIG. 2 is an exploded view of upper brake assembly or lower brake assembly shown in FIG. 1;

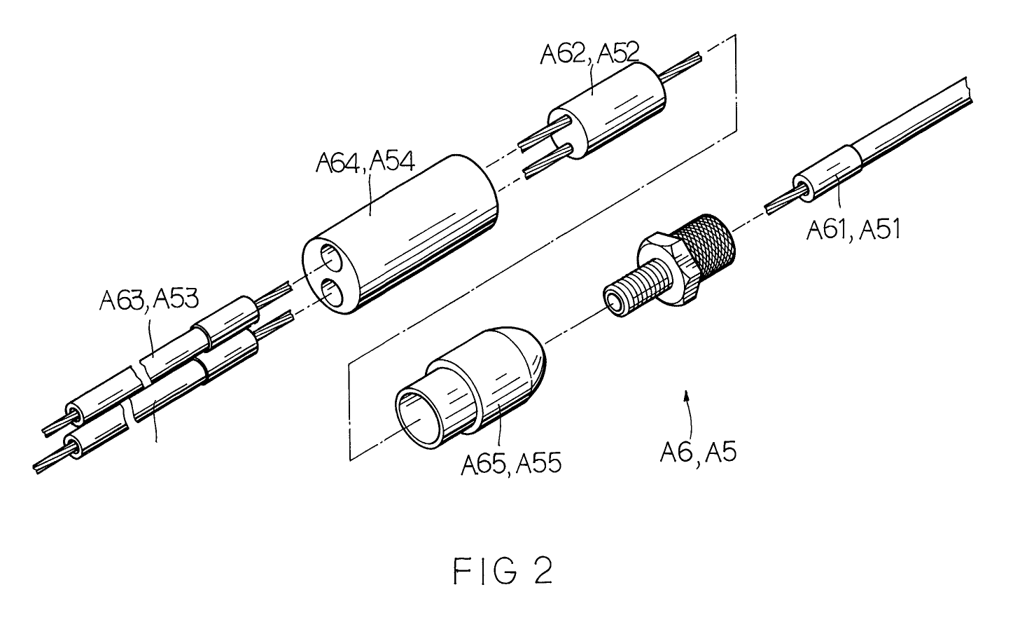

FIG. 3 is a sectional view of the FIG. 2 upper brake assembly or lower brake assembly;

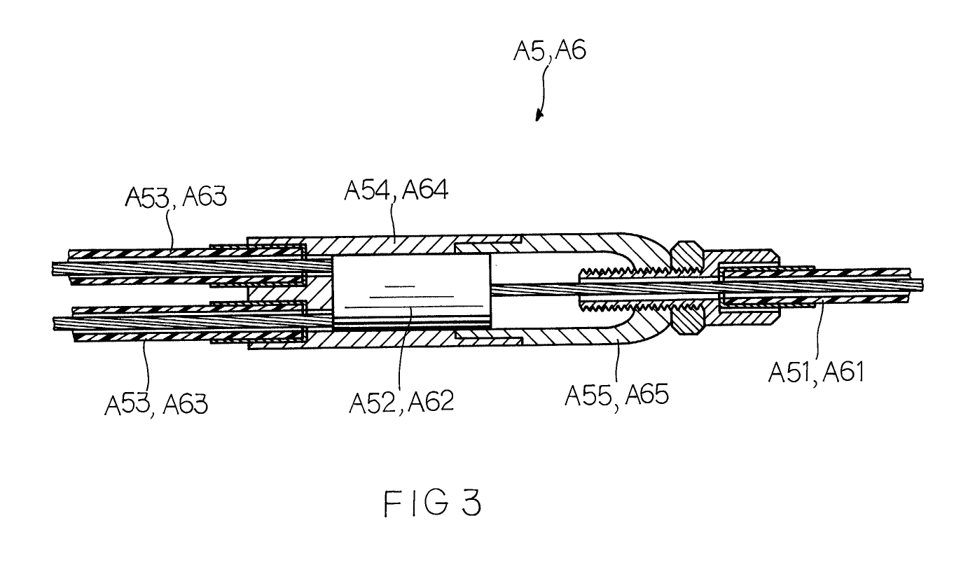

FIG. 4 is a perspective view of a rear brake cable mechanism mounted on a bicycle according to the invention;

FIG. 5 is an exploded view of upper brake assembly of FIG. 4; and

FIG. 6 is an exploded view of lower brake assembly of FIG. 4.

### DETAILED DESCRIPTION OF THE PREFERRED EMBODIMENTS

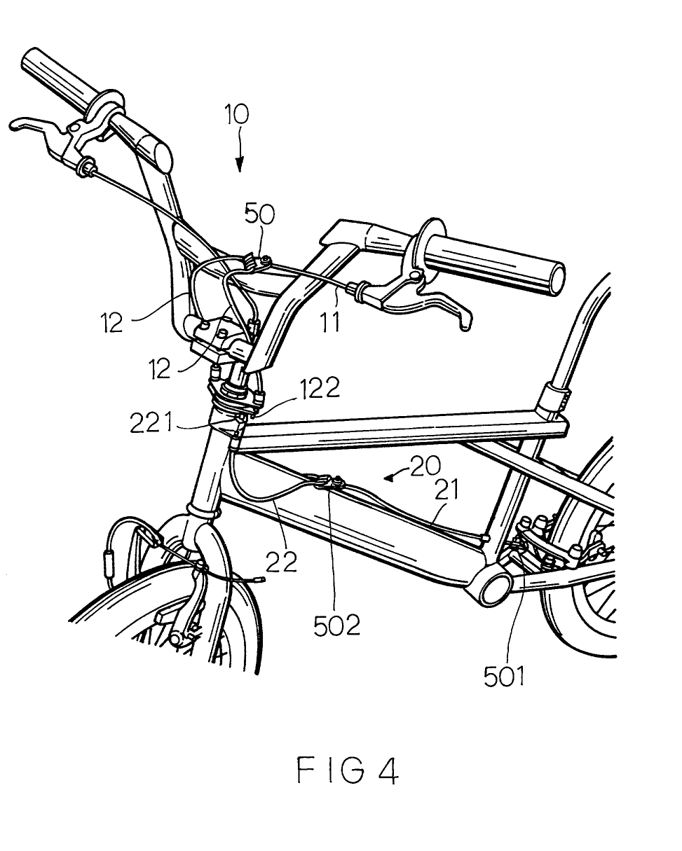

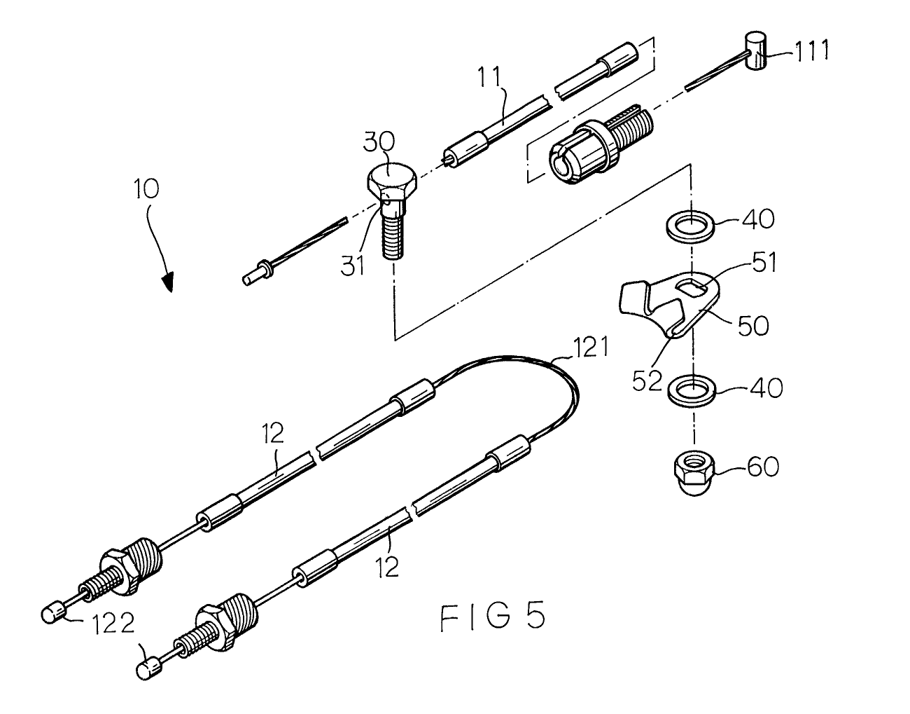

Referring to FIGS. 4 to 6, there is shown a brake mechanism for bicycle constructed in accordance with the invention. The rear brake cable mechanism of the brake mechanism comprises a brake cable assembly including a first cable 11 having a stop 111 in one end (FIG. 5) secured to brake lever, a second cable 12 having a stop 122 at either end secured to swivel and an unshielded section 121, a third cable 22 having a stop 221 at either end secured to swivel and an unshielded section 221, and a fourth cable 21 secured to rear brake, an upper brake assembly 10 on joint of first and second cables 11 and 12, and a lower brake assembly 20 coupled between third cable 21 and rear brake.

Referring to FIG. 5 specifically, the constituent components of upper brake assembly 10 will now be described in detail. Upper brake assembly 10 comprises a bolt 30 having a through hole 31 with first cable 11 secured thereto by an enlargement at the other end of first cable 11, an engagement member 50 comprising an aperture 51 with bolt 30 passed through and a bent fork section 52 with the unshielded section 121 of second cable 12 clung therein, a pair of washers 40 on the top and underside of engagement member 50 respectively, and a nut 60 put on the threaded section of bolt 30 to secure washers 40, engagement member 50 and bolt 30 together.

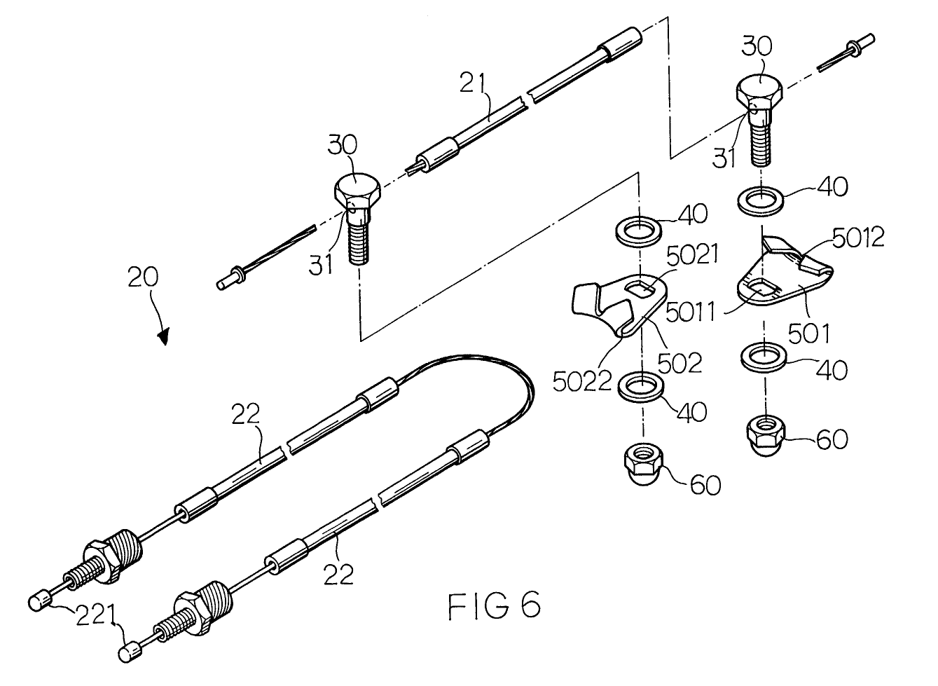

Referring to FIG. 6 specifically, the constituent components of lower brake assembly 20 will now be described in detail. Lower brake assembly 20 comprises a first section and a second section. The second section comprises a second bolt 30 having a through hole 31 with fourth cable 21 passed through, a second engagement member 501 comprising an aperture 5011 with second bolt 30 passed through and a bent fork section 5012 with an enlargement at one end of fourth cable 21 secured thereto, a pair of washers 40 on the top and underside of second engagement member 501 respectively, and a second nut 60 put on the threaded section of second bolt 30 to secure washers 40, second engagement member 501 and second bolt 30 together. The first section is substantially configured the same as upper brake assembly 10 shown in FIG. 5. For example, the first section of lower brake assembly 20 comprises a first bolt 30 having a through hole 31 with fourth cable 21 secured thereto by an enlargement at the other end of fourth cable 21, a first engagement member 502 comprising an aperture 5021 with first bolt 30 passed through and a bent fork section 5022 with the unshielded section 221 of third cable 22 clung therein, a pair of washers 40 on the top and underside of first engagement member 502 respectively, and a first nut 60 put on the threaded section of first bolt 30 to secure washers 40, first engagement member 502 and first bolt 30 together.

Operation: press the fork of brake lever toward each other to tauten first cable 11. Thus second, third, and fourth cables 12, 22, and 21 are moved through the cooperation of upper brake assembly 10 and lower brake assembly 20. As a result, rear brake is activated. It is important to note that the construction of the invention is simple. Also, each component of the upper brake assembly 10 and lower brake assembly 20 is detachable without any integral parts as experienced in the prior art. Most importantly, manufacturing cost is lowered.

While the invention has been described by means of specific embodiments, numerous modifications and variations could be made thereto by those skilled in the art without departing from the scope and spirit of the invention set forth in the claims.

What is claimed is:

1. A rear brake cable mechanism mounted on a bicycle comprising:
a brake cable assembly comprising a first cable having a stop in one end secured to said brake lever, a second cable having a stop at either end secured to a swivel at said joint of said front tube and said front fork, a third cable having a stop at either end secured to said swivel, and a fourth cable;
an upper brake assembly on said joint of said first and said second cables, said upper brake assembly comprising a first fastener having a through hole with said first cable secured thereto, and a first engagement member secured to said first fastener, said first engagement member having a bent fork section with said second cable clung therein; and
a lower brake assembly comprising a first section on said rear brake, said first section including a second fastener having a through hole with said fourth cable passed through, and a second engagement member secured to said second fastener, said second engagement member having a bent fork section secured to one end of said fourth cable; and a second section including a third fastener having a through hole with said other end of said fourth cable secured thereto, and a third engagement member including an aperture with said third fastener passed through, said third engagement member having a bent fork section with said third cable clung therein.
